(19) United States
(12) Patent Application Publication
(10) Pub. No.: US 2021/0206394 A1
(43) Pub. Date: Jul. 8, 2021

(54) WORK ASSIST SYSTEM AND WORK ASSIST METHOD

(71) Applicant: JVCKENWOOD Corporation, Yokohama-shi (JP)

(72) Inventors: Akinori Suyama, Yokohama-shi (JP); Hideki Takehara, Yokohama-shi (JP); Tatsumi Naganuma, Yokohama-shi (JP); Satoru Hirose, Yokohama-shi (JP); Takeshi Aoki, Yokohama-shi (JP); Yasushi Watanabe, Yokohama-shi (JP)

(21) Appl. No.: 17/211,896

(22) Filed: Mar. 25, 2021

Related U.S. Application Data
(63) Continuation of application No. PCT/JP2019/037266, filed on Sep. 24, 2019.

(30) Foreign Application Priority Data
Sep. 28, 2018 (JP) 2018-184845

(51) Int. Cl. B60W 60/00; G05D 1/00

(52) U.S. Cl. CPC B60W 60/0051; B60W 60/0013; G05D 2201/0213; G05D 1/0061; G05D 1/0088; B60W 60/0055

(57) ABSTRACT

A work assist system includes an automatic driving information acquisition unit configured to acquire automatic driving information containing automatic driving level information representing automatic driving levels from a vehicle capable of automatic driving; a task information storage configured to store task information containing unprocessed tasks to be processed by a driver of the vehicle, groups that classify the tasks according to functions required for processing the tasks, and the automatic driving levels necessary for processing the tasks using the functions corresponding to the groups; and a task extractor configured to extract a task that is processable by the driver in the vehicle based on the automatic driving information acquired by the automatic driving information acquisition unit and the task information stored in the task information storage.

### CROSS-REFERENCE TO RELATED APPLICATIONS

This application is a Continuation of PCT International Application No. PCT/JP2019/037266 filed on Sep. 24, 2019 which claims the benefit of priority from Japanese Patent Application No. 2018-184845 filed on Sep. 28, 2018, the entire contents of both of which are incorporated herein by reference.

### FIELD

The application relates to a work assist system and a work assist method.

### BACKGROUND

A technique to play a music or a video in order to spend time comfortably in a vehicle is known. Furthermore, a technique to play a video corresponding to a time expected to be taken by a vehicle to a destination is known (for example, refer to Japanese Laid-open Patent Publication No. 2002-344896).

It is expected that opportunities that a driver does work with a portable electronic device in a vehicle during automatic driving will increase as vehicle automatic driving spreads. A degree of involvement of a driver to the driving of the vehicle varies depending on the level of an automatic driving of the vehicle. Thus, it is preferable to provide assist to process processable work according to the automatic driving level of the vehicle.

### SUMMARY

A work assist system and a work assist method are disclosed.

According to one aspect, there is provided a work assist system comprising: an automatic driving information acquisition unit configured to acquire automatic driving information containing automatic driving level information representing automatic driving levels from a vehicle capable of automatic driving; a task information storage configured to store task information containing unprocessed tasks to be processed by a driver of the vehicle, groups that classify the tasks according to functions required for processing the tasks, and the automatic driving levels necessary for processing the tasks using the functions corresponding to the groups; and a task extractor configured to extract a task that is processable by the driver in the vehicle based on the automatic driving information acquired by the automatic driving information acquisition unit and the task information stored in the task information storage.

According to one aspect, there is provided a work assist method comprising: acquiring automatic driving information containing automatic driving level information representing automatic driving levels from a vehicle capable of automatic driving; storing, in a task information storage, task information containing unprocessed tasks to be processed by a driver of the vehicle, groups that classify the tasks according to functions required for processing the tasks, and the automatic driving levels necessary for processing the tasks using the functions corresponding to the groups; and extracting a task that is processable by the driver in the vehicle based on the automatic driving information that is acquired at the acquiring and the task information that is stored in the task information storage.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a schematic diagram illustrating an example of a configuration of a work assist system according to a first embodiment;

FIG. 2 is a table to explain automatic driving levels;

FIG. 3 is a schematic diagram illustrating an example of a configuration of a terminal device of a work assist system according to the first embodiment;

FIG. 4 is a schematic diagram illustrating an example of a configuration of a server device of the work assist system according to the first embodiment;

FIG. 5 is a table to explain an example of task information;

FIG. 6 is a flowchart representing a flow of processes in the terminal device of the work assist system according to the first embodiment;

FIG. 7 is a flowchart representing a flow of processes in the server device of the work assist system according to the first embodiment;

FIG. 8 is a flowchart representing a flow of processes in the terminal device of the work assist system according to the first embodiment;

FIG. 9 is a table to explain another example of the task information;

FIG. 10 is a flowchart representing a flow of processes in a terminal device of a work assist system according to a second embodiment;

FIG. 11 is a flowchart representing a flow of processes in a server device of the work assist system according to the second embodiment;

FIG. 12 is a table to explain another example of the task information;

FIG. 13 is a flowchart representing a flow of processes in a server device of a work assist system according to a third embodiment;

FIG. 14 is a schematic diagram illustrating another example of the configuration of the work assist system; and

FIG. 15 is a schematic diagram illustrating still another example of the configuration of the work assist system.

### DETAILED DESCRIPTION OF THE PREFERRED EMBODIMENTS

With reference to the accompanying drawings, embodiments of a work assist system and a work assist method according to the application will be described in detail below. The embodiments do not limit the application.

### First Embodiment

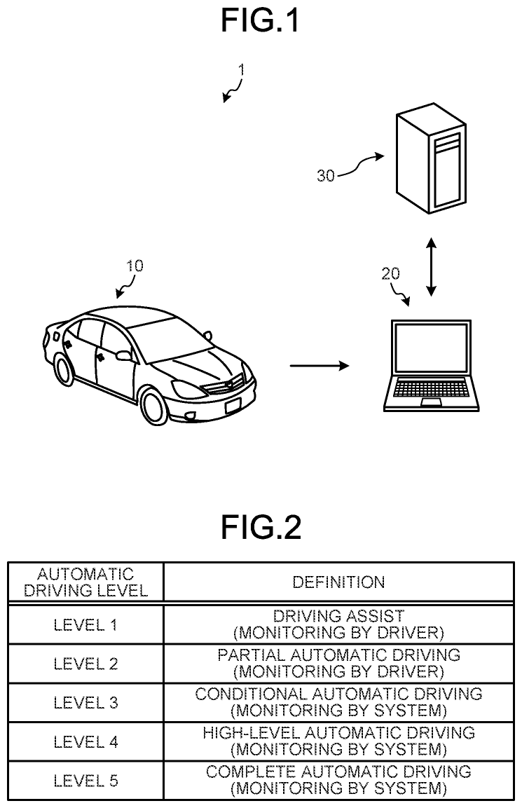

FIG. 1 is a schematic diagram illustrating an example of a configuration of a work assist system according to a first embodiment. A work assist system 1 assists a work in so-called “telework” that is flexible working regardless of time and a place by an information communication technology. In the first embodiment, particularly, a work during a travel by a vehicle capable of automatic driving is assisted. The work assist system 1 represents work tasks that are processable by the driver (hereinafter called “task”) according to the automatic driving level of a vehicle 10. The work assist system 1 includes a terminal device 20 that is brought into the vehicle 10 and a server device 30. In the work assist system 1, the terminal device 20 and the server device 30 are capable of communicating with each other.

The vehicle 10 outputs automatic driving information containing automatic driving level information representing the automatic driving level to the terminal device 20 via an electronic control unit (ECU) (not illustrated in the drawing). Alternatively, the vehicle 10 may output the automatic driving information containing the automatic driving level information to the terminal device 20 via a LIN by an operation on a button operated by the driver.

Using FIG. 2, the automatic driving levels will be described. FIG. 2 is a table to explain the automatic driving levels. At an automatic driving level 1, a system assists driving. For example, the system brakes, enables a travel following a preceding vehicle, and assists a travel not to deviate from a lane. At the automatic driving level 1, the driver monitors a traveling state of the vehicle 10.

At an automatic driving level 2, the automatic driving is executed partly. For example, the system enables a travel following a preceding vehicle in a fixed lane. At the automatic driving level 2, the driver monitors the traveling state of the vehicle 10.

At an automatic driving level 3, a conditional automatic driving is executed. More specifically, at the automatic driving level 3, the system executes all controls on driving. At the automatic driving level 3, when the system requests the driver to be involved in the driving, the driver has to respond the request. At the automatic driving level 3, the system monitors the traveling condition of the vehicle 10.

At the automatic driving level 4, a complete automatic driving is executed under a specific condition. At the automatic driving level 4, when the specific condition is met, the system executes all controls on driving. At the automatic driving level 4, the system monitors the driving state of the vehicle 10.

At an automatic driving level 5, a complete automatic driving is executed. At the automatic driving level 5, normally, the system keeps executing all controls on driving. At the automatic driving level 5, the system monitors the driving state of the vehicle 10.

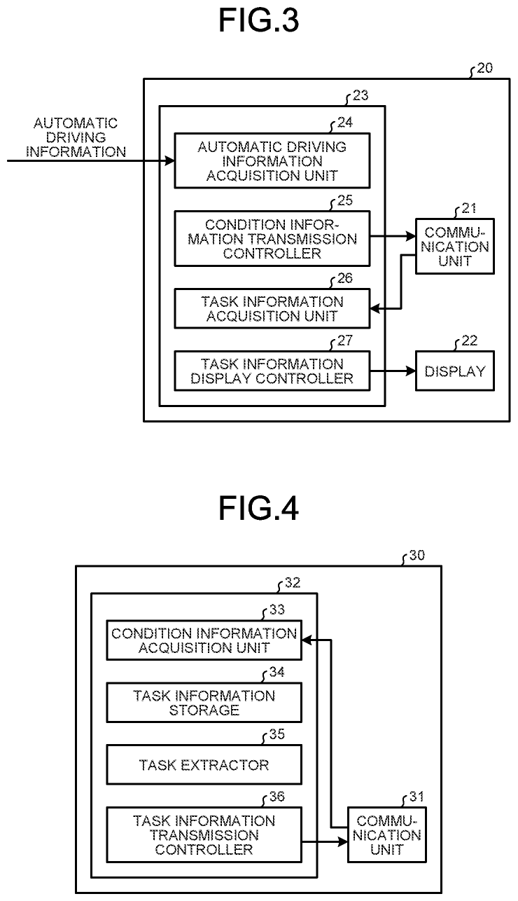

Using FIG. 3, the terminal device 20 will be described. FIG. 3 is a schematic diagram illustrating an example of a configuration of the terminal device of the work assist system according to the first embodiment. The terminal device 20 is a portable electronic device that is usable when the driver does work during a travel. The terminal device 20 is, for example, a portable electronic device including a laptop personal computer, a smartphone or a tablet. The terminal device 20 is usable in a facility of a work place of the driver and a site other than the facility of the work place of the driver. In the first embodiment, the terminal device 20 is used in the vehicle 10 capable of the automatic driving. In the first embodiment, the terminal device 20 requests the server device 30 to extract a task that is processable by the driver. The terminal device 20 includes a communication unit 21, a display 22, and a controller 23.

The communication unit 21 is a communication unit. The communication unit 21 enables a communication between the terminal device 20 and the server device 30.

The display 22 is a display including a liquid crystal display (LCD) or an organic electro-luminescence (EL) display. The display 22 may be dedicated to the work assist system 1 or, for example, may be shared with another system including a navigation system. The display 22 displays information on processable tasks based on a video signal that is output from a task information display controller 27 of the controller 23.

The controller 23 is, for example, a processing unit formed of, for example, a central processing unit (CPU), etc. The controller 23 loads a program that is stored in a storage (not illustrated in the drawing) and executes commands contained in the program. The controller 23 includes an internal memory (not illustrated in the drawing) and the internal memory is used to temporarily store data in the controller 23. The controller 23 includes an automatic driving information acquisition unit 24, a condition information transmission controller 25, a task information acquisition unit 26, and the task information display controller 27.

The automatic driving information acquisition unit 24 acquires automatic driving information containing the automatic driving level information representing the automatic driving level of the vehicle via a controller area network (CAN), a local interconnect network (LIN), or the like. The automatic driving information acquisition unit 24 may acquire the automatic driving information from the ECU via the CAN. The automatic driving information acquisition unit 24 may acquire the automatic driving information by an operation on a button operated by the driver via the LIN. The automatic driving information acquisition unit 24 outputs the acquired automatic driving information to the condition information transmission controller 25.

The condition information transmission controller 25 performs control such that condition information representing an extraction condition under which processable tasks are extracted is transmitted to the server device 30 via the communication unit 21. More specifically, the condition information transmission controller 25 extracts the automatic driving level information from the automatic driving information that is acquired by the automatic driving information acquisition unit 24 and regards the automatic driving level information as the condition information. The condition information transmission controller 25 performs control such that the condition information is transmitted to the server device 30 via the communication unit 21.

The task information acquisition unit 26 acquires task information representing the processable tasks that are extracted by the server device 30 via the communication unit 21.

The task information display controller 27 causes the display 22 to display the task information that is acquired by the task information acquisition unit 26. For example, the task information display controller 27 may display the task information in a list.

The task information display controller 27 may display all the task information that is acquired by the task information acquisition unit 26 and, for example, may display a limited number of sets of the task information.

Using FIG. 4, the server device 30 will be described. FIG. 4 is a schematic diagram illustrating an example of a configuration of the server device of the work assist system according to the first embodiment. The server device 30 is a server device that manages tasks that have been done using the terminal device 20 and unprocessed tasks to be done. The server device 30 is run in a facility of the work place of the drive or in a cloud. In the first embodiment, the server device 30 extracts tasks processable by the driver according to the automatic driving level of the vehicle 10 and transmits the tasks to the terminal device 20. The server device 30 includes a communication unit 31 and a controller 32.

The communication unit 31 is a communication unit. The communication unit 31 enables a communication between the server device 30 and the terminal device 20.

The controller 32 is a processing unit formed of, for example, a central processing unit (CPU), etc. The controller 32 loads a program that is stored in a storage (not illustrated in the drawing) and executes commands contained in the program. The controller 32 includes an internal memory (not illustrated in the drawing) and the internal memory is used to temporarily store data in the controller 32. The controller 32 includes a condition information acquisition unit 33, a task information storage 34, a task extractor 35, and a task information transmission controller 36.

The condition information acquisition unit 33 acquires the condition information from the terminal device 20 via the communication unit 31. In the first embodiment, the condition information acquisition unit 33 acquires the automatic driving level information as the condition information.

The task information storage 34 stores the task information. The task information is information on unprocessed tasks that are tasks to be done by the driver. The unprocessed tasks include a task to be processed for the first time and a task that has not been completed and is to be further processed. The task information is registered by the driver in advance. Also, for example, the information on unprocessed tasks acquired by analyzing data that is stored in the terminal device 20 or a processing history may be registered as the task information. Alternatively, for example, the information on unprocessed tasks acquired from a work management system that is used by the driver (not illustrated in the drawing) may be registered as the task information.

The task information includes groups, unprocessed tasks, and required driving levels. More specifically, the task information includes the unprocessed tasks, groups that classify the unprocessed tasks according to functions that are required for processing the tasks, and the automatic driving levels required for processing the tasks using the functions corresponding to the groups. In the first embodiment, the unprocessed tasks are classified into a group that requires a voice input/output unit, a group that requires a display, and a group that requires an input unit.

The unprocessed tasks are tasks to be processed by the driver and that have not been processed. The unprocessed tasks may include one for which the terminal device 20 is used and one for which the terminal device 20 is not used.

In each group, the automatic driving level that allows the processing using the function is set as a required automatic driving level. The unprocessed task in the group requiring the voice input/output unit is executable by sound. The unprocessed task in the group requiring the voice input/output unit is executable without a line-of sight movement of the driver or a movement of hand fingers. The unprocessed task in the group requiring the voice input/output unit is thus processable at all automatic driving levels. The unprocessed task in the group requiring the voice input/output unit is processable at or above the automatic driving level 1. The task requiring the display requires the driver to look at the display. In other words, the task requiring the display requires the driver to move the line-of sight to the display. The unprocessed task in the group requiring the display is thus processable when the system monitors the traveling state of the vehicle 10. The unprocessed task in the group requiring the display is processable at or above the automatic driving level 3. The unprocessed task in the group requiring the input unit requires the driver to move the hand fingers. Thus, the unprocessed task in the group requiring the input unit is processable when the driver need not be involved in the driving. The unprocessed task in the group requiring the input unit is processable at or above an automatic driving level 4.

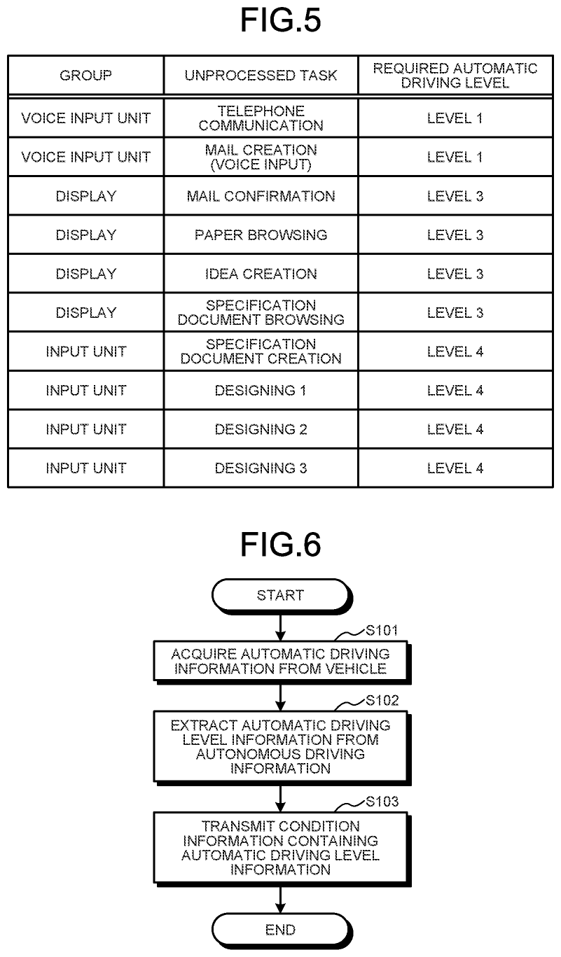

Using FIG. 5, an example of the task information will be described. FIG. 5 is a table to explain an example of the task information. As the unprocessed tasks in the group requiring the voice input/output unit, a telephone communication and a mail creation by voice input are stored. The required automatic driving level of the unprocessed tasks in the group requiring the voice input/output unit is the level 1. As the unprocessed tasks in the group requiring the display, a mail confirmation, a paper browsing, an idea creation, and a specification document browsing are stored. The required automatic driving level of the unprocessed tasks in the group requiring the display is the level 3. As the unprocessed tasks in the group requiring the input unit, a specification document creation, designing 1, designing 2, and designing 3 are stored. The required automatic driving level of the unprocessed tasks in the group requiring the input unit is the level 4.

Based on the automatic driving information contained in the condition information and the task information that is stored in the task information storage 34, the task extractor 35 extracts a task that is processable by the driver in the vehicle 10 according to the automatic driving level. More specifically, based on the automatic driving level information and the task information, the task extractor 35 extracts, as the processable task, a task contained in a group of which a required automatic driving level is at or under the automatic driving level of the vehicle 10. For example, when the automatic driving level of the vehicle 10 is the level 3, the task extractor 35 extracts, as the processable tasks, the unprocessed tasks contained in the group of which the required driving levels corresponds to the level 3, the level 2, and the level 1.

The task extractor 35 may extract all or, for example, a limited number of the tasks that are processable by the driver in the vehicle 10 according to the automatic driving level.

The task information transmission controller 36 transmits the task information on the processable tasks that are extracted by the task extractor 35 to the terminal device 20 via the communication unit 31.

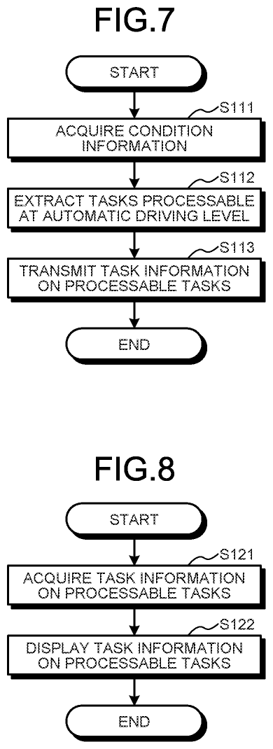

Using FIGS. 6 to 8, a flow of processes in the work assist system 1 will be described. FIG. 6 is a flowchart representing the flow of the processes in the terminal device of the work assist system according to the first embodiment. FIG. 7 is a flowchart representing a flow of processes in the server device of the work assist system according to the first embodiment. FIG. 8 is a flowchart representing a flow of processes in the terminal device of the work assist system according to the first embodiment.

When the driver performs a pushing operation on a process start button in order to execute an unprocessed task using the terminal device 20, the processes of the flowchart represented in FIG. 6 is executed. Alternatively, when the vehicle 10 starts the automatic driving, the processes of the flowchart represented in FIG. 6 may be executed.

By the automatic driving information acquisition unit 24, the controller 23 of the terminal device 20 acquires the automatic driving information from the vehicle (step S101). More specifically, by the automatic driving information acquisition unit 24, the controller 23 acquires the automatic driving information containing the automatic driving level information representing the automatic driving level of the vehicle 10 via a CAN, a LIN, or the like. The controller 23 then proceeds to step S102.

By the condition information transmission controller 25, the controller 23 extracts the automatic driving level information from the automatic driving information that is acquired by the automatic driving information acquisition unit 24 (step S102). The controller 23 then proceeds to step S103.

By the condition information transmission controller 25, the controller 23 transmits the condition information containing the automatic driving level information (step S103). More specifically, the controller 23 performs control such that the condition information transmission controller 25 transmits the automatic driving level information as the condition information to the server device 30 via the communication unit 21. The controller 23 then ends the process.

When the terminal device 20 transmits the condition information to the server device 30, the process of the flowchart represented in FIG. 7 is executed.

By the condition information acquisition unit 33, the controller 32 of the server device 30 acquires the condition information from the terminal device 20 (step S111). More specifically, by the condition information acquisition unit 33, the controller 32 acquires the automatic driving level information as the condition information from the terminal device 20. The controller 23 then proceeds to step S112.

By the task extractor 35, the controller 32 extracts the tasks that are processable at the automatic driving level of the vehicle 10 (step S112). More specifically, based on the automatic driving level information contained in the condition information and the task information that is stored in the task information storage 34, the controller 32 extracts, by the task extractor 35, the tasks contained in the groups of which the required automatic driving levels are at or under the automatic driving level of the vehicle 10. The controller 32 then proceeds to step S113.

For example, when the task information represented in FIG. 5 is stored and the automatic driving level of the vehicle 10 is the level 3, the controller 32 extracts, as the processable tasks, the unprocessed tasks contained in the groups requiring the display and the voice input/output unit of which the required driving levels correspond to the level 3 and the level 1, by the task extractor 35. The extracted processable tasks are a telephone communication, a mail creation by voice input, a mail confirmation, a paper browsing, an idea creation, and a specification document browsing.

By the task information transmission controller 36, the controller 32 transmits the task information on the processable tasks (step S113). More specifically, by the task information transmission controller 36, the controller 32 transmits the task information on the processable tasks that are extracted by the task extractor 35 to the terminal device 20 via the communication unit 31. The controller 32 then ends the process.

When the extracted task information is transmitted from the server device 30 to the terminal device 20, the process of the flowchart represented in FIG. 8 is executed.

By the task information acquisition unit 26, the controller 23 of the terminal device 20 acquires the task information on the processable tasks (step S121). More specifically, the controller 23 acquires, via the communication unit 21, the task information representing the processable tasks that are extracted by the server device 30. The controller 23 then proceeds to step S122.

By the task information display controller 27, the controller 23 causes the display 22 to display the information on the processable tasks (step S122). More specifically, by the task information display controller 27, the controller 23 causes the display 22 to display the task information in a list. The controller 23 then ends the process.

The driver chooses the task from among the processable tasks that are displayed in a list on the display 22 and performs a pushing operation on an execution button. On detecting the pushing operation, the terminal device 20 starts a program for executing the task, for example, each of various functions of, for example, a telephone communication, an electronic mail, a document creation, and a document browsing.

As described above, the unprocessed tasks are classified according to the groups of the functions required for execution and are stored. Furthermore, in each of the groups, the automatic driving level allowing the processing using the corresponding function is set. According to the automatic driving level of the vehicle 10, the tasks that are processable by the driver in the vehicle 10 are extracted from the task information that is stored in the task information storage 34.

As described above, in the first embodiment, the unprocessed tasks are classified according to the groups of the functions required for execution and are stored. In the first embodiment, the automatic driving level allowing the processing using the corresponding function is set per group. In the first embodiment, it is possible to extract a task that is processable by the driver in the vehicle 10 according to the automatic driving level of the vehicle 10 from the task information that is stored in the task information storage 34. More specifically, according to the first embodiment, it is possible to extract, as the processable task, the task contained in the group of which the required automatic driving level is at or under the automatic driving level of the vehicle 10 based on the automatic driving level of the vehicle 10 and the task information.

In the first embodiment, the unprocessed task in the group requiring the voice input/output unit is processable at all the automatic driving levels. In the first embodiment, the unprocessed task in the group requiring the display is processable when the system monitors the traveling state of the vehicle 10. In the first embodiment, the unprocessed task in the group requiring the display is processable at or above the automatic driving level 3. Furthermore, in the first embodiment, the unprocessed task in the group requiring the input unit is processable when the driver need not be involved in the driving. In the first embodiment, the unprocessed task in the group requiring the input unit is processable at or above the automatic driving level 4. As described above, in the first embodiment, it is possible to appropriately extract only tasks that are processable by the driver in the vehicle 10 according to the automatic driving level of the vehicle 10. According to the first embodiment, it is possible to inhibit a task that is not preferable to execute at the automatic driving level of the vehicle 10 from being processed.

As described above, in the first embodiment, representing the processable tasks to the driver according to the automatic driving level of the vehicle 10 makes it possible to assist work during the travel by the vehicle that is capable of the automatic driving. According to the first embodiment, since the processable tasks are represented, it is possible to improve work efficiency.

### Second Embodiment

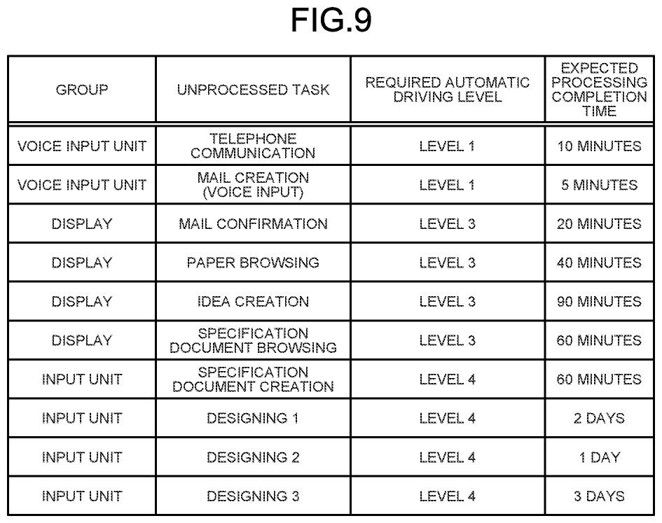

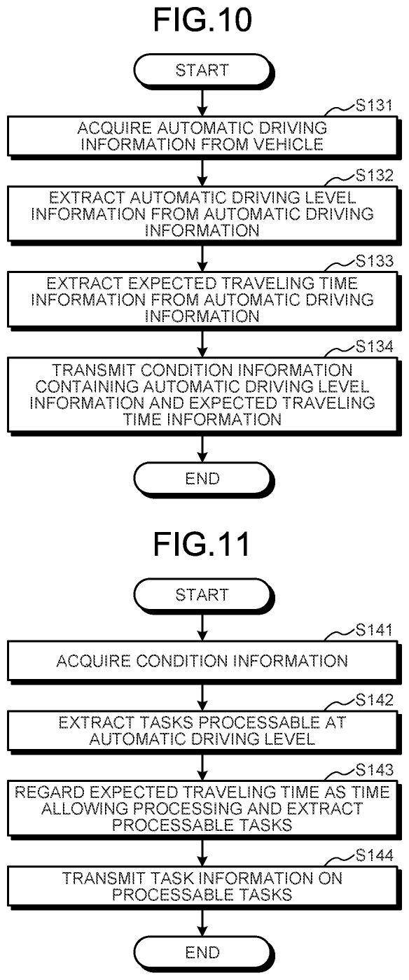

With reference to FIGS. 9 to 11, the work assist system 1 according to a second embodiment will be described. FIG. 9 is a table to explain another example of the task information. FIG. 10 is a flowchart representing a flow of processes in a terminal device of a work assist system according to the second embodiment. FIG. 11 is a flowchart representing a flow of processes in a server device of the work assist system according to the second embodiment. Basic configurations of the terminal device 20 and the server device 30 are the same as those of the terminal device 20 and the server device 30 of the first embodiment. In the following description, the same components as those of the terminal device 20 and the server device 30 are denoted with the same reference numbers or corresponding numbers and detailed description thereof will be omitted. In the second embodiment, the processes performed by the automatic driving information acquisition unit 24, the condition information transmission controller 25, and the task information display controller 27 differ from those of the first embodiment. In the second embodiment, the processes performed by the condition information acquisition unit 33, the task information storage 34, and the task extractor 35 differ from those of the first embodiment.

The automatic driving information acquisition unit 24 acquires the automatic driving information containing the automatic driving level information representing the automatic driving level of the vehicle 10 and expected traveling time information representing an expected traveling time to be taken by the vehicle 10 to travel to a destination via a CAN, a LIN, or the like.

The condition information transmission controller 25 extract, as the condition information, the automatic driving level information and the expected traveling time information from the automatic driving information that is acquired by the automatic driving information acquisition unit 24. The condition information transmission controller 25 performs control such that the condition information is transmitted to the server device 30 via the communication unit 21.

The task information display controller 27 may display all the task information that is acquired by the task information acquisition unit 26 or may display, for example, a given limited number of sets of the task information in ascending or descending order of an expected processing completion time.

The condition information acquisition unit 33 acquires the automatic driving level information and the expected traveling time information as the condition information.

The task information storage 34 stores the task information containing the groups, the unprocessed tasks, the required driving levels, and expected processing completion times.

The expected processing completion time is a time required to complete the processing of the unprocessed task.

Using FIG. 9, another example of the task information will be described. The task information represented in FIG. 9 is obtained by adding information of the expected processing completion times to the task information represented in FIG. 5. As for the task of a telephone communication, 10 minutes is stored as an expected processing completion time. As for the task of a mail creation by voice input, 5 minutes is stored as an expected processing completion time. As for the task of a mail confirmation, 20 minutes is stored as an expected processing completion time. As for the task of a paper browsing, 40 minutes is stored as an expected processing completion time. As for the task of an idea creation, 90 minutes is stored as an expected processing completion time. As for the task of a specification document browsing, 60 minutes is stored as an expected processing completion time. As for the task of a specification document creation, 60 minutes is stored as an expected processing completion time. As for the task of designing 1, 2 days is stored as an expected processing completion time. As for the task of designing 2, 1 day is stored as an expected processing completion time. As for the task of designing 3, 3 days is stored as an expected processing completion time.

Based on the automatic driving information contained in the condition information and the task information that is stored in the task information storage 34, the task extractor 35 extracts a task that is processable by the driver in the vehicle 10 according to the automatic driving level and the expected traveling time. More specifically, based on the automatic driving level information, the expected traveling time information, and the task information, the task extractor 35 extracts, as the processable task, a task that is contained in the group of which the required automatic driving level is at or under the automatic driving level of the vehicle 10 and of which the expected processing completion time is at or under the expected traveling time.

The task extractor 35 may extract all the tasks that are processable by the driver in the vehicle 10 according to the automatic driving level or may extract, for example, a given limited number of the tasks in ascending or descending order of the expected processing completion time.

Using FIGS. 10 and 11, a flow of processes in the work assist system 1 will be described.

The same process as that of steps S101 and S102 in the flowchart represented in FIG. 6 is performed as the process of steps S131 and S132.

The controller 23 extracts the expected traveling time information from the automatic driving information that is acquired by the automatic driving information acquisition unit 24 (step S133). The controller 23 then proceeds to step S134.

By the condition information transmission controller 25, the controller 23 transmits the condition information containing the automatic driving level information and the expected traveling time information (step S134). More specifically, the controller 23 performs control such that the condition information transmission controller 25 transmits the automatic driving level information and the expected traveling time information as the condition information to the server device 30 via the communication unit 21. The controller 23 then ends the process.

The same process as that of steps S111, S112 and S113 in the flowchart represented in FIG. 7 is performed as the process of steps S141, S142 and S144.

By the task extractor 35, the controller 32 regards the expected traveling time as a time allowing the processing and extracts the processable tasks (step S143). More specifically, by the task extractor 35, the controller 32 extracts, as the processable tasks, the tasks of which the expected processing completion times are at or under the expected traveling time from among the tasks that are extracted at step S142. The controller 32 then proceeds to step S144.

For example, when the task information represented in FIG. 9 is stored, the automatic driving level of the vehicle 10 is the level 3, and the expected traveling time is 30 minutes, the controller 32 extracts, as the processable tasks, the unprocessed tasks of which the required driving levels are the level 3 or the level 1 and of which the expected processing completion times are equal to or less than 30 minutes, by the task extractor 35. The processable tasks to be extracted are a telephone communication, a mail creation by voice input, and a mail confirmation.

As described above, the expected processing completion times are further stored for the unprocessed tasks. From the task information that is stored in the task information storage 34, the tasks that are processable by the driver in the vehicle 10 are extracted according to the automatic driving level of the vehicle 10 and the expected traveling time.

As described above, in the second embodiment, the expected processing times are further stored for the unprocessed tasks. According to the second embodiment, it is possible to extract the task that is processable by the driver in the vehicle 10 according to the automatic driving level of the vehicle 10 and the expected traveling time from the task information that is stored in the task information storage 34. More specifically, according to the second embodiment, it is possible to extract, as the processable task, the task that is contained in the group of which the required automatic driving level is at or under the automatic driving level of the vehicle 10 and of which the expected processing completion time is equal to or less than the expected traveling time, based on the automatic driving level information in the vehicle 10, the expected traveling time, and the task information. As described above, in the second embodiment, it is possible to assist work more appropriately by representing the processable tasks which is more appropriate to be performed.

### Third Embodiment

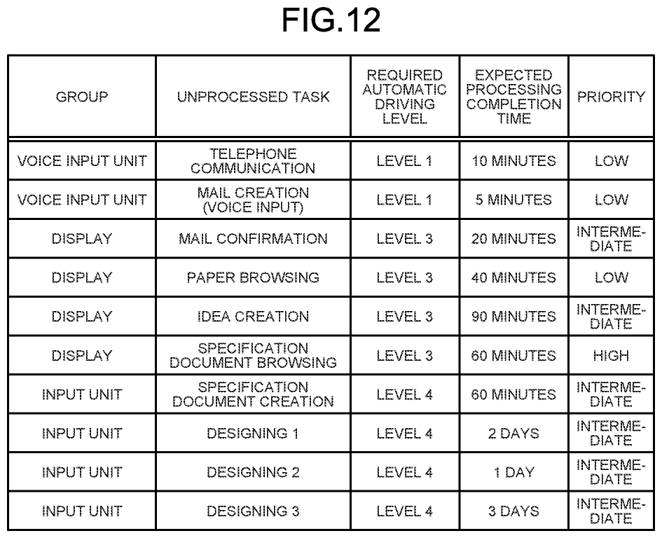

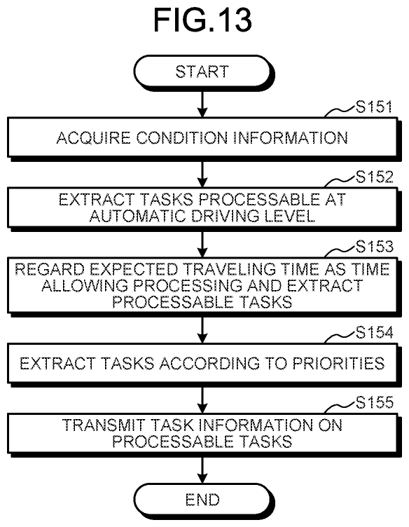

With reference to FIGS. 12 and 13, the work assist system 1 according to a third embodiment will be described. FIG. 12 is a table to explain another example of the task information. FIG. 13 is a flowchart representing a flow of processes in a server device of a work assist system according to the third embodiment. In the third embodiment, the processes performed by the task information display controller 27, the task information storage 34 and the task extractor 35 differ from those in the second embodiment.

The task information display controller 27 may display all the task information that is acquired by the task information acquisition unit 26 or may display, for example, a given limited number of sets of the task information in descending order of priority.

The task information storage 34 stores the task information containing the groups, the unprocessed tasks, the required driving levels, the expected processing completion times, and priorities.

A priority is a priority in processing tasks. In the third embodiment, a priority is represented by high, intermediate, and low. A task with a high priority is a task which is preferable to be completed preferentially.

Using FIG. 12, another example of the task information will be described. The task information represented in FIG. 12 is obtained by adding information of the priorities to the task information represented in FIG. 9. As for the task of a telephone communication, “low” is stored as a priority. As for the task of a mail creation by voice input, “low” is stored as a priority. As for the task of a mail confirmation, “intermediate” is stored as a priority. As for the task of a paper browsing, “low” is stored as a priority. As for the task of an idea creation, “intermediate” is stored as a priority. As for the task of a specification document browsing, “high” is stored as a priority. As for the task of a specification document creation, “intermediate” is stored as a priority. As for the task of designing 1, “intermediate” is stored as a priority. As for the task of designing 2, “intermediate” is stored as a priority. As for the task of designing 3, “intermediate” is stored as a priority.

Based on the automatic driving information contained in the condition information and the task information that is stored in the task information storage 34, the task extractor 35 extracts the task that is processable by the driver in the vehicle 10 according to the automatic driving level and the priority. In the third embodiment, based on the automatic driving level information, the expected traveling time information, and the task information, the task extractor 35 extracts, as the processable task, a task that is contained in the group of which the required automatic driving level is at or under the automatic driving level of the vehicle 10 and of which the expected processing completion time is equal to or less than the expected traveling time according to the priority.

The task extractor 35 may extract all the tasks that are processable by the driver in the vehicle 10 according to the automatic driving level or may extract, for example, a given limited number of the tasks in descending order of the priority.

Using FIG. 13, a flow of processes in the work assist system 1 will be described.

The same process as that of steps S141 to S143 and S144 in the flowchart represented in FIG. 11 is performed as the process of steps S151 to S153 and S155.

By the task extractor 35, the controller 32 extracts the processable tasks according to the priority from among the tasks that are extracted at step S153 (step S154). More specifically, by the task extractor 35, the controller 32 extracts, from the tasks extracted at step S153, the processable tasks in descending order of the priority. The controller 32 then proceeds to step S155.

For example, the case where the task information represented in FIG. 12 is stored, the automatic driving level of the vehicle 10 is the level 3, the expected traveling time is 30 minutes, and two tasks are extracted in descending order of the priority will be described. First of all, the unprocessed tasks of which the required driving levels are the level 3 and the level 1 and of which the expected processing completion times is equal to or less than 30 minutes are extracted. The unprocessed task with the highest priority is then extracted from among the extracted unprocessed tasks. In this manner, a mail confirmation is extracted as the processable task.

As descried above, the priorities are further stored for the unprocessed tasks. The tasks processable by the driver in the vehicle 10 are extracted according to the automatic driving level of the vehicle 10 and the priorities from the task information that is stored in the task information storage 34.

As described above, in the third embodiment, the priorities are further stored for the unprocessed tasks. According to the third embodiment, it is possible to extract the tasks processable by the driver in the vehicle 10 according to the automatic driving level of the vehicle 10 and the priorities from the task information that is stored in the task information storage 34. More specifically, according to the third embodiment, it is possible to extract a task that is the task contained in the group of which the required automatic driving level is at or under the automatic driving level of the vehicle 10 and of which the expected processing completion time is equal to or less than the expected traveling time according to the priority, based on the automatic driving level information on the vehicle 10, the expected traveling time, and the task information. As described above, in the third embodiment, it is possible to assist work more appropriately by representing the processable tasks which is more appropriate to be performed.

The work assist system 1 according to the application has been described and the work assist system 1 may be carried out in various different modes in addition to the above-described embodiments.

Each component of the work assist system 1 illustrated in the drawings is functionally schematic and need not necessarily be physically configured as illustrated in the drawings. In other words, a specific mode of each device is not limited to those illustrated in the drawings, and all or part of the components may be functionally or physically distributed or integrated in a given unit according to the load of processing or usage of each device.

The configuration of the work assist system 1 is, for example, implemented by a program that is loaded in a memory as software. In the above-described embodiments, the configuration is described as functional blocks that are implemented by association of these sets of hardware or hardware. In other words, these functional blocks can be implemented in various forms using only hardware, software, or a combination of hardware and software.

The components described above include those easily achieved by those skilled in the art and those substantially the same. Furthermore, the above-described components can be combined as appropriate. Various omissions, replacements and changes of the components can be made within the scope of the application.

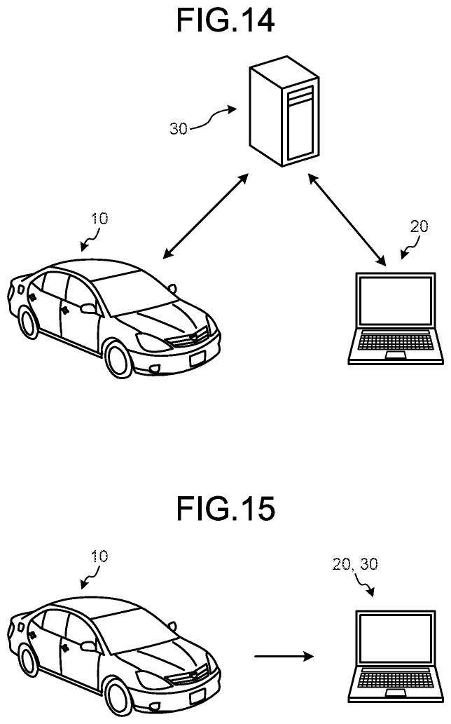

In the work assist system 1, the vehicle 10, the terminal device 20, and the server device 30 are not limited to the configuration illustrated in FIG. 1 and may be configured as illustrated in FIGS. 14 and 15. FIG. 14 is a schematic diagram illustrating another example of the configuration of the work assist system. FIG. 15 is a schematic diagram illustrating still another example of the configuration of the work assist system.

For example, as illustrated in FIG. 14, the server device 30 and the vehicle 10 may be connected such that they communicate with each other, and also the server device 30 and the terminal device 20 may be connected such that they communicate with each other. In this case, the vehicle 10 transmits the automatic driving information to the server device 30. The terminal device 20 may acquire the automatic driving information from the vehicle 10 via the server device 30. Alternatively, using the condition information acquisition unit 33, the server device 30 may acquire the automatic driving information as condition information from the vehicle 10.

For example, as illustrated in FIG. 15, the terminal device 20 may have the function of the server device 30. In this case, even when the terminal device 20 is not connected to a communication network, the terminal device 20 is capable of executing the process of each of the functions of the work assist system 1.

The terminal device 20 is described above as a device in which the task information display controller 27 causes the display 22 to display the processable tasks. However, the display is not limited thereto, and the processable tasks can be preferably represented to the driver. For example, in the terminal device 20, when a processable task is to be executed, the program of each of the functions may be started normally and, when a task not included in the processable tasks is to be executed, a message representing that the task cannot be executed may be displayed and the program of each of the functions cannot be started.

According to the application, an effect that it is possible to provide assist to process processable work according to an automatic driving level of a vehicle is achieved.

Although the invention has been described with respect to specific embodiments for a complete and clear application, the appended claims are not to be thus limited but are to be construed as embodying all modifications and alternative constructions that may occur to one skilled in the art that fairly fall within the basic teaching herein set forth.

What is claimed is:

1. A work assist system comprising:
an automatic driving information acquisition unit configured to acquire automatic driving information containing automatic driving level information representing automatic driving levels from a vehicle capable of automatic driving;
a task information storage configured to store task information containing unprocessed tasks to be processed by a driver of the vehicle, groups that classify the tasks according to functions required for processing the tasks, and the automatic driving levels necessary for processing the tasks using the functions corresponding to the groups; and
a task extractor configured to extract a task that is processable by the driver in the vehicle based on the automatic driving information acquired by the automatic driving information acquisition unit and the task information stored in the task information storage.

2. The work assist system according to claim 1, wherein
the automatic driving information acquisition unit is further configured to acquire the automatic driving information containing the automatic driving level information and expected traveling time information representing an expected time to be taken by the vehicle to travel to a destination; and
the task extractor is further configured to extract a task that is processable by the driver in the vehicle based on the automatic driving information acquired by the automatic driving information acquisition unit and the task information stored in the task information storage.

3. The work assist system according to claim 2, wherein the task information storage is further configured to store the task information further containing priority information representing priorities of processing the tasks, and
the task extractor is further configured to extract a task that is processable by the driver in the vehicle based on the automatic driving information acquired by the automatic driving information acquisition unit and the task information stored in the task information storage.

4. A work assist method comprising:
acquiring automatic driving information containing automatic driving level information representing automatic driving levels from a vehicle capable of automatic driving;
storing, in a task information storage, task information containing unprocessed tasks to be processed by a driver of the vehicle, groups that classify the tasks according to functions required for processing the tasks, and the automatic driving levels necessary for processing the tasks using the functions corresponding to the groups; and
extracting a task that is processable by the driver in the vehicle based on the automatic driving information that is acquired at the acquiring and the task information that is stored in the task information storage.
